(19) United States
(12) Patent Application Publication
(10) Pub. No.: US 2014/0150905 A1
(43) Pub. Date: Jun. 5, 2014

(54) CHECK VALVE

(71) Applicant: Nyloncraft, Inc., Mishawaka, IN (US)

(72) Inventor: Bernard Joseph Sparazynski, South Bend, IN (US)

(73) Assignee: Nyloncraft, Inc., Mishawaka, IN (US)

(21) Appl. No.: 14/172,113

(22) Filed: Feb. 4, 2014

Related U.S. Application Data
(63) Continuation-in-part of application No. 12/700,391, filed on Feb. 4, 2010.

(51) Int. Cl. F16K 15/14

(52) U.S. Cl. CPC F16K 15/14
USPC 137/512; 137/843

(57) ABSTRACT

A check valve which is positioned in the vacuum air line of an internal combustion engine. The check valve includes a single-piece valve body having an outlet port and two or more inlet ports, with one outlet port located substantially in line with the inlet port and connected by a venturi tube. The second inlet port is separated from the main air flow line by the valve stem and a diaphragm which allows communication there between and prevents back pressure. The second inlet port communicates with the outlet port through the valve stem and a second venturi tube which provides a vacuum boost to a device, usually vehicle brakes, connected to the inlet. The use of seal diaphragms having a non-constant radius allows for faster recovery time for replenishment than prior art devices.

### CROSS-REFERENCE TO RELATED APPLICATIONS

The present invention is a continuation in part of and claims priority to U.S. patent application Ser. No. 12/700,391, filed Feb. 4, 2010, and having the title CHECK VALVE, which is herein incorporated by reference.

### FIELD OF THE DISCLOSED EMBODIMENTS

This present disclosure relates to valves, and will have application to check valves used in internal combustion engines.

### BACKGROUND OF THE DISCLOSED EMBODIMENTS

Internal combustion engines have long employed air flow conduits to provide vacuum assist for automobile subsystems, such as brakes, automatic transmissions and others. These systems often employed check valves located along the air flow conduit to prevent subsystem back pressure from reaching the engine. A typical check valve of this sort is described in U.S. Pat. No. 3,889,710.

Prior check valves employed either a continuous diameter airway or employed multiple valves and hoses to create a venturi effect and act as a vacuum booster for the subsystem to which it was associated. Space limitations in the automobile engine compartment all but preclude the use of multiple valve-hose systems, while the prior art continuous diameter airways did not provide the increased power boost desired to implement the brakes or other subsystems.

An improvement to these prior check valve designs is disclosed in U.S. Reissued Pat. No. RE 37,090. A check valve is disclosed in that patent which is positioned in the vacuum air line of an internal combustion engine. The check valve includes a single-piece valve body having an outlet port and two or more inlet ports, with one outlet port located substantially in line with the inlet port and connected by a venturi tube. The second inlet port is separated from the main air flow line by the valve stem and a diaphragm which allows communication therebetween and prevents back pressure. The second inlet port communicates with the outlet port through the valve stem and a second venturi tube which provides a vacuum boost to a device, usually vehicle brakes, connected to the inlet.

While this check valve represented an improvement over prior art designs, modern applications continue to demand improvements in performance. For example, in internal combustion engine applications where such check valves are used, the recovery time for replenishment of the brake booster system after depletion is a critical performance factor. Accordingly, any improvements that allow for faster recovery times are needed.

### SUMMARY OF THE DISCLOSED EMBODIMENTS

In one embodiment, a check valve is disclosed, comprising: a valve body having a first air inlet port, an air outlet port in air flow communication with said first air inlet port to define a first air passageway, a second air inlet port in air flow communication with said first air inlet port and said air outlet port wherein air is drawn from said second air inlet port towards said air outlet port; a valve positioned between said first air passageway and said second air inlet port for inhibiting air flow from said first air passageway through said second air inlet port, said valve comprising: a valve seat positioned between said first and second inlet ports having an opening communicating with said first air passageway; and a flexible seal diaphragm positioned in said valve seat for responding to air exiting said second air inlet port under outside vacuum influence and for seating against said valve seat to prevent air flow from said first air passageway from exiting through said second air inlet port; wherein said flexible seal diaphragm has a non-constant radius; and a venturi conduit positioned between said first air inlet port and said outlet port, said venturi conduit enhancing air flow through said outlet port with a corresponding enhancement of air drawn from said second air inlet port towards said outlet port; wherein said venturi conduit is positioned immediately adjacent said valve seat opening to provide maximum vacuum boost through the valve seat.

In another embodiment, a check valve is disclosed, comprising: a valve body having a first air inlet port, an air outlet port in air flow communication with said first air inlet port to define a first air passageway, a second air inlet port in air flow communication with said first air inlet port and said air outlet port wherein air is drawn from said second air inlet port towards said air outlet port; a valve positioned between said first air passageway and said second air inlet port for inhibiting air flow from said first air passageway through said second air inlet port, said valve comprising: a valve seat positioned between said first and second inlet ports having an opening communicating with said first air passageway; and a flexible seal diaphragm positioned in said valve seat for responding to air exiting said second air inlet port under outside vacuum influence and for seating against said valve seat to prevent air flow from said first air passageway from exiting through said second air inlet port; wherein said flexible seal diaphragm has a non-constant radius.

In yet another embodiment, a check valve is disclosed, comprising: a first inlet port; an outlet port; a valve seat positioned between said first inlet port and said outlet port; and a flexible seal diaphragm positioned in said valve seat for preventing fluid flow from said outlet port to said first inlet port by seating against said valve seat when such flow begins to occur; wherein said flexible seal diaphragm has a non-constant radius.

### BRIEF DESCRIPTION OF THE DRAWINGS

An embodiment of the invention has been depicted for illustrative purposes only wherein:

FIG. 1 is a plan view of one embodiment of a check valve.

FIG. 2 is a cross-sectional view taken along line 2-2 of FIG. 1.

FIG. 3 is a plan view of the lower valve port.

FIG. 4 is an exploded perspective view of the check valve incorporating prior art seal diaphragms.

FIG. 5 is an exploded perspective view of the check valve incorporating new seal diaphragms.

FIG. 6 is a plan view of one embodiment of seal diaphragm.

FIGS. 7A-D are plan views of other embodiments of seal diaphragms.

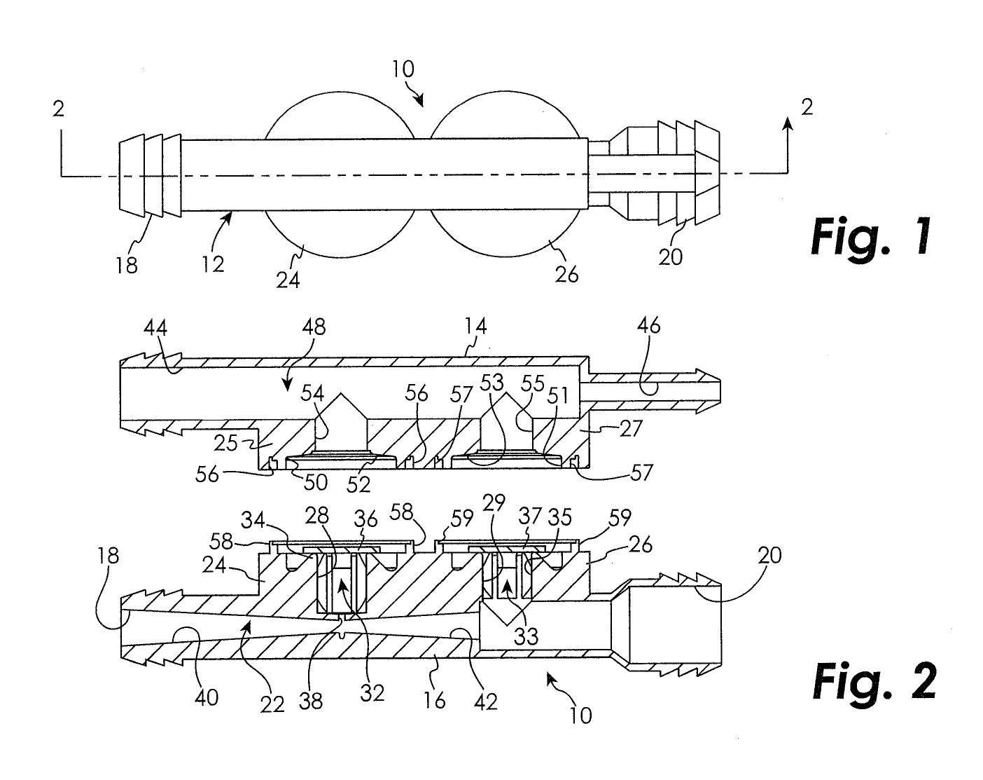

### DETAILED DESCRIPTION OF THE DISCLOSED EMBODIMENTS

For the purposes of promoting an understanding of the principles of the invention, reference will now be made to certain embodiments and specific language will be used to describe the same. It will nevertheless be understood that no limitation of the scope of the invention is thereby intended, and alterations and modifications in the illustrated device, and further applications of the principles of the invention as illustrated therein are herein contemplated as would normally occur to one skilled in the art to which the invention relates.

Referring now to the drawings, a check valve is illustrated and generally referred to as 10. Check valve 10 is normally employed in an internal combustion engine in the air flow line between the engine block and the air intake port at the full mixing port, normally a carburetor or fuel injection port. For clarity, the engine, carburetor, hose connections, and subsystems are not shown, and it is understood that these ports are common to the internal combustion engines found in almost all vehicles.

The air flow system in the typical internal combustion engine operates on the principle that as the engine operates, a partial vacuum is created which pulls air through the air intake port of the carburetor of fuel injector to aid in proper fuel combustion. This vacuum has been found to be useful in supplementing vacuum assist subsystems in the vehicle, particularly brakes, automatic transmissions and air conditioners. Check valve 10 provides the connection between the main airway and the subsystem and serves to inhibit back pressure from the subsystem from disturbing airflow through the main airway.

Check valve 10 shown in the drawings includes a substantially one piece valve body 12 which is preferably formed of a top valve half 14 and a bottom valve half 16. The designations of top and bottom halves are for descriptive purposes only and are not limitative of the orientation of valve 10 in the engine compartment. Preferably, top valve half 14 is joined to bottom valve half 16 by sonic welding, heating or other conventional method in order to form the substantially one piece valve body 12 prior to its use.

Bottom valve half 16 includes an air inlet 18 and an air outlet 20 which are in direct air flow communication via air passageway 22. In typical use in an internal combustion engine, air inlet 18 will be connected via a conduit (not shown) to the air intake port to receive filtered ambient air (not shown). Air outlet 20 is preferably connected via a conduit (not shown) to the vacuum port of the engine intake manifold (not shown).

As shown, bottom valve half 16 also includes lower valve seats 24, 26. Each lower valve seat 24, 26 is defined by a continuous outer wall 28, 29, and a bottom wall 30, 31. A bore 32, 33 is defined in each lower valve seat 24, 26 to allow for air flow communication with air passageway 22. Each outer wall 28, 29 may include stepped portion 58, 59 as shown to provide for ease in mating with upper valve seats 25, 27, as described later in this specification. A plurality of radially spaced fingers 34, 35 extend integrally upwardly from each bottom wall 30, 31 and serve to support a flexible seal diaphragm diaphragm member 36, 37. Air passageway 22 has an opening 38 which allows for air communication between the passageway and valve seat 24.

Air passageway 22 is defined by a tapering outer passage 40 which narrows from inlet port 18 up to the opening 38, and a widening passage 42 from opening 38 to the intersection of passageway 22 and valve seat 26. This configuration of passageway 22 is commonly known as a venturi conduit, whose functions are well known to those skilled in the art.

Upper valve half 14 is adopted to mate with lower valve half 16 to form check valve 10. Upper valve half 14 as shown includes inlet 44 and inlet 46 which may be connected in air flow communication by air passageway 48. In a typical connection to an internal combustion engine, inlet 44 will be connected via an air hose (not shown) to a brake system (not shown) and inlet 46 will be either capped or connected to another subsystem of a vehicle, such as the air conditioner compressor (not shown).

As shown, upper valve half 14 includes valve seats 25, 27. Each upper valve seat 25, 27 is defined by continuous outer wall 50, 51 and bottom wall 52, 53. A bore 54, 55 is defined in each upper valve seat 25, 27 to allow for air communication with air passageway 48 and inlets 44, 46. Bottom walls 52, 53 are preferably of a smooth concave configuration as shown with bores 54, 55 of a slightly lesser maximum diameter than that of seal diaphragm diaphragms 36, 37. Each outer wall 50, 51 preferably has a circumferential groove 56, 57 substantially complemental to the stepped portion 58, 59 of the lower valve seats 24, 26.

Check valve 10 is assembled by aligning valve seats 24, 26 with valve seats 25, 27 such that stepped portions 58, 59 are aligned with grooves 56, 57. Seal diaphragm diaphragms 36, 37 are placed on valve seats 52, 53, and the valve parts 14, 16 are then pressed together and joined as by sonic welding or other common method. The method use to join valve parts 14, 16 will generally depend on the material used to form the valve parts, in this embodiment an injection molded heat resistant, rigid plastic. It is understood that a suitable plastic or metal or other compound may be used in forming check valve 10, which is now ready for implementation in the internal combustion engine as follows.

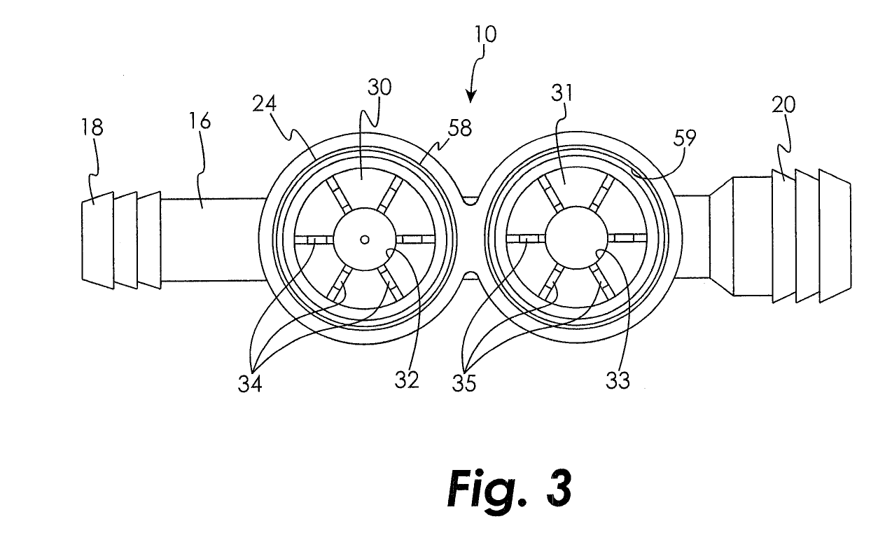

With the above hose hook-ups mentioned above, check valve 10 functions as follows. As the engine (not shown) operates, it draws air through inlet 18, passageway 22 and outlet 20. This creates a partial vacuum in valve seats 24-27 and passageway 48 to draw seal diaphragms 36, 37 downward against fingers 34, 35. Due to the spacing of fingers 34, 35 (FIG. 3) free air flow from passageway 48 to passageway 22 is allowed. The partial vacuum created by the operation of the engine serves in the vacuum assistance of the operation of the brake, and, if desired, HVAC subsystems (not shown) in a common manner.

If for any reason, back pressure in one of the subsystems is generated to create a positive air flow through passageway 48 to inlets 44, 46 a reverse flow vacuum is generated to draw seal diaphragms 36, 37 tight against valve seat bottom walls 52, 53 to prevent the vacuum from interfering with the above described air flow through passageway 22.

As shown in FIG. 2 of the present invention, the tapering and widening passageways, 40, 42 create a venturi effect on the partial vacuum generated during the operation of the engine (not shown). By their configurations, passageways 40, 42 allow for an increase in the velocity with reduced pressure of the air passing through passageway 42. Due to the connection of passageway 22 and valve seats 24, 25, and an increase in the amount of air drawn through passageway 48 and valve seats 25, 24 provides a significant boost in the vacuum assist for the connected subsystems (not shown). The functioning of check valve 10 as thus far described is well-known to those skilled in the art.

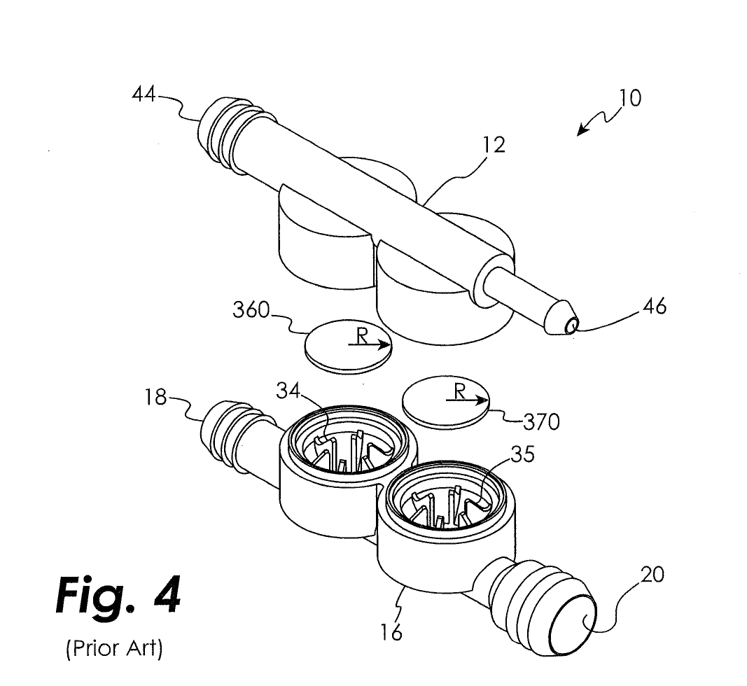

Prior art check valves constructed according to the design of check valve 10 included seal diaphragms 360 and 370 having a circular configuration and a substantially constant radius R as shown in FIG. 4. As an example, such a prior art check valve 10 was tested in a lab environment utilizing a vacuum pump which pulls a vacuum of seventeen inches of mercury (17″ Hg) at the outlet 20. The observed vacuum at outlet 44 using constant radius seal diaphragms 360, 370 in place reached the indicated pressures at the corresponding elapsed times shown in Table 1.

TABLE 1
Recovery time for replenishment using
prior art seal diaphragms 360, 370.

| In Hg | Time (sec.) |
|---|---|
| 17 | 5.25 |
| 20 | 18.8 |
| 21.5 | 39 |

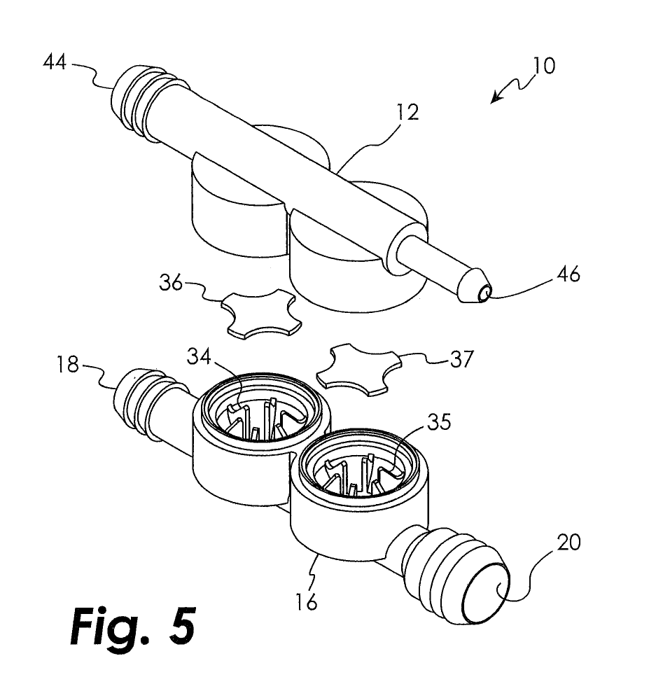

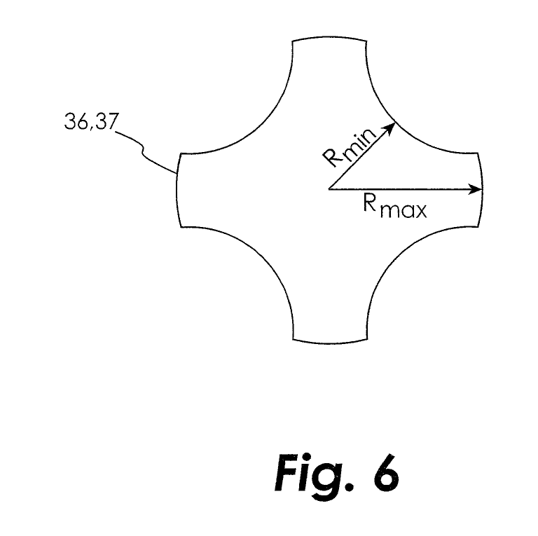

The present disclosure replaces the prior art seal diaphragms 360, 370 with seal diaphragms 36, 37 that have variable radiuses, such as those shown in FIG. 5 and detailed in FIG. 6. The flexible seal diaphragms 36, 37 has an outer radius positioned at an outer radial distance from a center point of the flexible seal diaphragm. The flexible seal diaphragm includes cutouts positioned along the outer radius. The cutouts have a radially inward end that is positioned at an inner radial distance from the centerpoint that is less than the outer radial distance. The seal diaphragms 36, 37 have a non-constant radius, with the circumference varying from a minimum radius Rₘᵢₙ to a maximum radius Rₘₐₓ. Rₘᵢₙ is chosen to be larger than the diameter of bores 54, 55 of valve seats 25, 27, such that the seal diaphragms 36, 37 will seat against bores 54, 55 to prevent back pressure in passageway 48 from interfering with air flow through passageway 22. Rₘₐₓ is large enough that it will keep the seal diaphragm 36, 37 substantially centered in the valve in order to ensure proper seating of the seal diaphragm 36, 37 with the valve seats 25, 27.

When air is flowing from passageway 48 to passageway 22 such that the valves are open, the areas of reduced radius (i.e. radii less than Rₘₐₓ) allow for increased air flow through the valves. Such increased air flow allows for faster recovery time when replenishing the vacuum of devices coupled to the valve 10. As an example, the check valve 10 using seal diaphragms 36, 37 was tested as above by pulling a vacuum of seventeen inches of mercury (17″ Hg) at the outlet 20. The observed vacuum at outlet 44 using non-constant radius seal diaphragms 36, 37 in place reached the indicated pressures at the corresponding elapsed times shown in Table 2.

TABLE 2
Recovery time for replenishment using seal diaphragms 36, 37.

| In Hg | Time (sec.) | Improvement |
|---|---|---|
| 17 | 4.74 | 9.71% |
| 20 | 14.78 | 21.38% |
| 21.5 | 28.85 | 26.03% |

As can be seen, the recovery time for replenishment of the vacuum using the seal diaphragms 36, 37 was up to 26.03% faster than when using the prior art seal diaphragms 360, 370. Such faster recovery times allow for increased performance of the subsystems coupled to the valve 10.

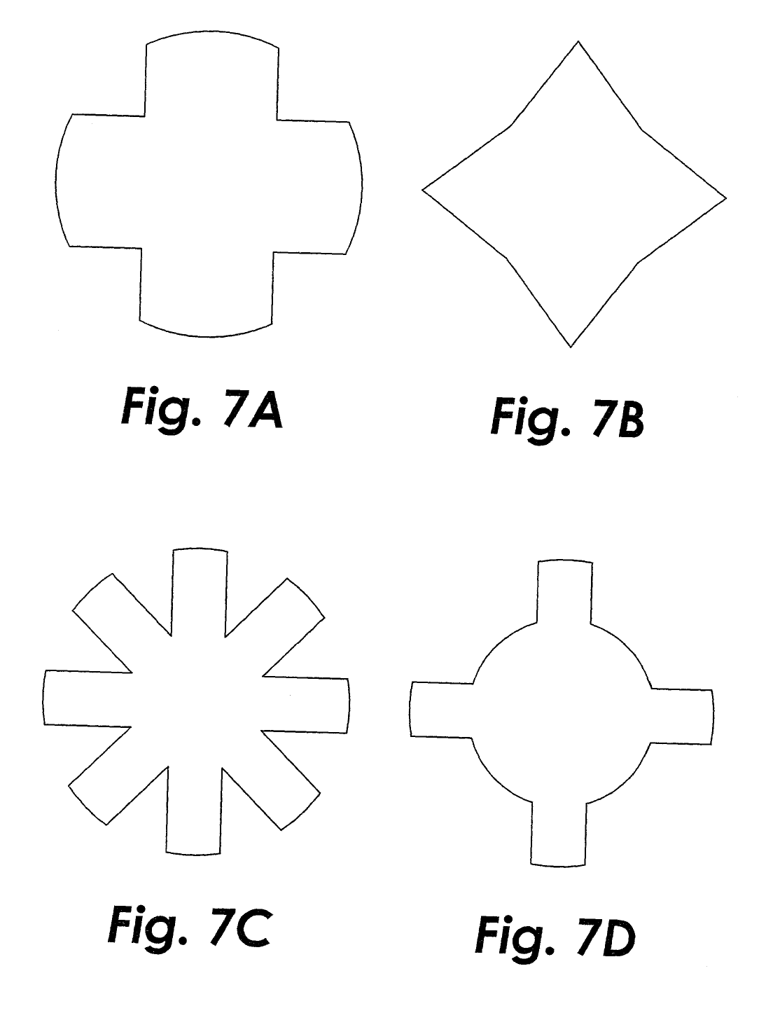

It will be appreciated from the above disclosure that the specific shape of the seal diaphragms 36, 37 is not critical, so long as they exhibit non-constant radii, have a minimum radius Rₘᵢₙ that allows them to seal the diaphragm against the valve seats 25, 27, and a maximum radius Rₘₐₓ that maintains the desired position of the seal diaphragm 36, 37 within the valve. FIGS. 7A-D illustrate additional seal diaphragms that exhibit these features. Countless others will be apparent to those skilled in the art in view of the present disclosure.

It will be appreciated from the above disclosure that the check valve disclosed herein will be useful in any application requiring a check valve, and not just in the check valve shown in the illustrated embodiment. For example, the check valve disclosed herein will be useful in applications as simple as requiring only one input port and one output port, where it is desired to prevent fluid flow in the direction from the outlet port toward the inlet port. Those skilled in the art will also understand that the check valve disclosed herein will be useful to check any fluid flow, from gas to fluid to viscous fluids.

While the invention has been illustrated and described in detail in the drawings and foregoing description, the same is to be considered as illustrative and not restrictive in character, it being understood that only certain embodiments have been shown and described and that all changes and modifications that come within the spirit of the invention are desired to be protected.

What is claimed is:

1. A check valve, comprising:
a valve body having a first air inlet port, an air outlet port in air flow communication with said first air inlet port to define a first air passageway, a second air inlet port in air flow communication with said first air inlet port and said air outlet port wherein air is drawn from said second air inlet port towards said air outlet port;
a valve positioned between said first air passageway and said second air inlet port for inhibiting air flow from said first air passageway through said second air inlet port, said valve comprising:
a valve seat positioned between said first and second inlet ports having an opening communicating with said first air passageway; and
a flexible seal diaphragm positioned in said valve seat for responding to air exiting said second air inlet port under outside vacuum influence and for seating against said valve seat to prevent air flow from said first air passageway from exiting through said second air inlet port;
wherein said flexible seal diaphragm has an outer radius positioned at an outer radial distance from a center point of the flexible seal diaphragm, and wherein said flexible seal diaphragm includes cutouts positioned along the outer radius, the cutouts having a radially inward end that is positioned at an inner radial distance from the center point that is less than the outer radial distance; and
a venturi conduit positioned between said first air inlet port and said outlet port, said venturi conduit enhancing air flow through said outlet port with a corresponding enhancement of air drawn from said second air inlet port towards said outlet port;
wherein said venturi conduit is positioned immediately adjacent said valve seat opening to provide maximum vacuum boost through the valve seat.

2. The check valve of claim 1, further comprising:
a third air inlet port in air flow communication with said second air inlet port to define a second air passageway in said valve body, said valve positioned between said first air passageway and said second air passageway.

3. The check valve of claim 2, wherein said valve includes first and second spaced valve seats, each valve seat including a flexible seal diaphragm positioned in the valve seat for responding to air exiting one of said second and third air inlet ports under outside vacuum influence and for seating against its associated valve seat to prevent air flow from said first air passageway from exiting through its respective second and third air inlet ports.

4. The check valve of claim 3, wherein said venturi conduit has a tapered central portion of narrowed diameter immediately adjacent said valve seat opening.

5. A check valve, comprising:
a valve body having a first air inlet port, an air outlet port in air flow communication with said first air inlet port to define a first air passageway, a second air inlet port in air flow communication with said first air inlet port and said air outlet port wherein air is drawn from said second air inlet port towards said air outlet port;
a valve positioned between said first air passageway and said second air inlet port for inhibiting air flow from said first air passageway through said second air inlet port, said valve comprising:
a valve seat positioned between said first and second inlet ports having an opening communicating with said first air passageway; and
a flexible seal diaphragm positioned in said valve seat for responding to air exiting said second air inlet port under outside vacuum influence and for seating against said valve seat to prevent air flow from said first air passageway from exiting through said second air inlet port;
wherein said flexible seal diaphragm has an outer radius positioned at an outer radial distance from a center point of the flexible seal diaphragm, and wherein said flexible seal diaphragm includes cutouts positioned along the outer radius, the cutouts having a radially inward end that is positioned at an inner radial distance from the center point that is less than the outer radial distance.

6. The check valve of claim 5, further comprising:
a venturi conduit positioned between said first air inlet port and said outlet port, said venturi conduit enhancing air flow through said outlet port with a corresponding enhancement of air drawn from said second air inlet port towards said outlet port;
wherein said venturi conduit is positioned immediately adjacent said valve seat opening to provide maximum vacuum boost through the valve seat.

7. The check valve of claim 5, further comprising:
a third air inlet port in air flow communication with said second air inlet port to define a second air passageway in said valve body, said valve positioned between said first air passageway and said second air passageway.

8. The check valve of claim 7, wherein said valve includes first and second spaced valve seats, each valve seat including a flexible seal diaphragm positioned in the valve seat for responding to air exiting one of said second and third air inlet ports under outside vacuum influence and for seating against its associated valve seat to prevent air flow from said first air passageway from exiting through its respective second and third air inlet ports.

9. The check valve of claim 6, wherein said venturi conduit has a tapered central portion of narrowed diameter immediately adjacent said valve seat opening.

10. The check valve of claim 7, wherein substantially all of the air drawn from said first air inlet port flows through said first air passageway towards said air outlet port and substantially all of the air drawn from said second air inlet port flows through both of said first and second air passageways towards said air outlet port.

11. The check valve of claim 7, wherein said second air passageway includes a second venturi conduit positioned between said second air inlet port and said air outlet port.

12. A check valve, comprising:
a first inlet port;
an outlet port;
a valve seat positioned between said first inlet port and said outlet port; and
a flexible seal diaphragm positioned in said valve seat for preventing fluid flow from said outlet port to said first inlet port by seating against said valve seat when such flow begins to occur;
wherein said flexible seal diaphragm has an outer radius positioned at an outer radial distance from a center point of the flexible seal diaphragm, and wherein said flexible seal diaphragm includes cutouts positioned along the outer radius, the cutouts having a radially inward end that is positioned at an inner radial distance from the centerpoint that is less than the outer radial distance.

13. The check valve of claim 12, further comprising:
a valve body incorporating the first inlet port, the outlet port, a first fluid passageway defined between the first inlet port and the outlet port, a second inlet port in fluid flow communication with said first inlet port and said outlet port wherein fluid is drawn from said second inlet port towards said outlet port;
said valve seat positioned between said first fluid passageway and said second inlet port for inhibiting fluid flow from said first fluid passageway through said second inlet port; and
a venturi conduit positioned between said first inlet port and said outlet port, said venturi conduit enhancing air flow through said outlet port with a corresponding enhancement of air drawn from said second inlet port towards said outlet port;
wherein said venturi conduit is positioned immediately adjacent said valve seat opening to provide maximum vacuum boost through the valve seat.

14. The check valve of claim 13, further comprising:
a third inlet port in fluid flow communication with said second inlet port to define a second fluid passageway in said valve body, said valve positioned between said first fluid passageway and said second fluid passageway.

15. The check valve of claim 14, wherein said valve includes first and second spaced valve seats, each valve seat including a flexible seal diaphragm positioned in the valve seat for responding to fluid exiting one of said second and third inlet ports under outside vacuum influence and for seating against its associated valve seat to prevent fluid flow from said first fluid passageway from exiting through its respective second and third inlet ports.

16. The check valve of claim 15, wherein said venturi conduit has a tapered central portion of narrowed diameter immediately adjacent said valve seat opening.

17. The check valve of claim 12, wherein said fluid comprises air.
